(19) United States
(12) Patent Application Publication
(10) Pub. No.: US 2019/0295122 A1
(43) Pub. Date: Sep. 26, 2019

(54) METHOD AND APPARATUS FOR FACILITATING MANAGEMENT OF ADVERTISEMENT CAMPAIGNS

(71) Applicant: [24]7.ai, Inc., San Jose, CA (US)

(72) Inventors: Gaurav Kumar, San Jose, CA (US); Nitin Gupta, San Jose, CA (US); Priyank Garg, Bangalore (IN)

(21) Appl. No.: 16/363,770

(22) Filed: Mar. 25, 2019

(30) Foreign Application Priority Data
Mar. 26, 2018 (IN) 201841011007

(51) Int. Cl. G06Q 30/02

(52) U.S. Cl. CPC G06Q 30/0244; G06Q 30/0277; G06Q 30/0272; G06Q 30/0255

(57) ABSTRACT

A method and apparatus for facilitating management of a digital Ad campaign are disclosed. The method includes causing display of a user interface (UI) to provide options to an advertiser to select one or more demand-side platforms (DSPs) in relation to an Ad campaign. A selection of the one or more DSPs with a selection of a respective frequency capping condition for each DSP is received along with a selection of an overall frequency capping condition. A number of Ad impressions related to the Ad campaign for an online visitor is tracked. At least one DSP is caused to stop display of one or more advertisements to the online visitor for a predefined time period if at least one of the overall frequency capping condition and the respective frequency capping condition associated with the at least one DSP is satisfied based on the tracking of the number of Ad impressions.

### CROSS REFERENCE TO RELATED APPLICATIONS

This application claims priority to Indian provisional patent application No. 201841011007, filed Mar. 26, 2018, which is incorporated herein in its entirety by this reference thereto.

### TECHNICAL FIELD

The present technology generally relates to digital advertising, and more particularly to a method and apparatus for facilitating management of digital advertisement campaigns.

### BACKGROUND

Many enterprises rely on digital advertising to communicate with existing and potential users of their products, services and/or information offerings. For example, the enterprises may display advertisements or ‘Ads’ on Ad publishing channels, such as third-party websites, to attract customer traffic through their content.

Generally, enterprises launch Ad campaigns involving either a single advertisement or a series of related advertisements to be displayed to targeted users for a pre-specified time period to promote a new product or service, to increase brand awareness, and the like. Accordingly, the enterprises may employ advertising agencies and/or marketers (hereinafter collectively referred to as ‘Ad campaign managers’) to manage the Ad campaigns.

The Ad campaign managers typically use a Demand-Side Platform (DSP) to run Ad campaigns for the enterprises. A DSP provides a single interface to an Ad campaign manager to manage multiple Ad exchanges for buying advertisement slots on websites and other such Ad publishers.

Most Ad campaign managers, nowadays, select multiple DSPs so that they can reach more Ad inventories and can take advantage of different features including targeting strategies offered by multiple DSPs. For example, some DSPs are good in providing better reach in specific regions, some DSPs are good in providing better click through rates, while some DSPs are good in providing better Ad views. Each of these metrics carry some weightage for a campaign to execute optimally and as a result, picking one DSP for an Ad campaign is a sub-optimal solution because it requires an Ad campaign manager to compromise on one feature versus other.

However, managing an Ad campaign optimally across multiple DSPs is complicated and requires substantial effort on the part of the Ad campaign manager. For example, optimally managing a frequency capping configuration across multiple DSPs is especially challenging. Frequency capping relates to frequency with which an Ad is shown to a targeted user within a specified time period. Furthermore, because frequency capping is also directly connected with reach because the number of unique impressions also varies based on frequency capping, optimally managing the frequency capping configuration becomes a mission critical item for some Ad campaigns.

### SUMMARY

In an embodiment of the invention, a computer-implemented method for facilitating management of a digital advertisement (Ad) campaign is disclosed. The method causes, by a processor, a display of a user interface (UI) configured to provide options to an advertiser to select one or more demand-side platforms (DSPs) in relation to the Ad campaign. The method receives, by the processor, a selection of the one or more DSPs provided by the advertiser using the UI. The selection of each DSP from among the one or more DSPs is associated with a selection of a respective frequency capping condition by the advertiser. The method receives, by the processor, a selection of an overall frequency capping condition provided by the advertiser using the UI. The overall frequency capping condition is selected in relation to the Ad campaign. Subsequent to receiving the selection of the respective frequency capping condition for each DSP and the overall frequency capping condition for the Ad campaign, the method tracks by the processor, a number of Ad impressions related to the Ad campaign for an online visitor. The method determines, by the processor, whether at least one of the overall frequency capping condition and the respective frequency capping condition associated with at least one DSP from among the one or more DSPs is satisfied based on the tracking of the number of Ad impressions. The method causes the at least one DSP, by the processor, to stop display of one or more advertisements associated with the Ad campaign to the online visitor for a predefined time period if it is determined that at least one of the overall frequency capping condition and the respective frequency capping condition associated with the at least one DSP is satisfied.

In an embodiment, an apparatus for facilitating management of a digital advertisement (Ad) campaign is disclosed. The apparatus includes a processor and a memory. The memory stores instructions. The processor is configured to execute the instructions and thereby cause the apparatus to display a user interface (UI) configured to provide options to an advertiser to select one or more demand-side platforms (DSPs) in relation to the Ad campaign. The apparatus receives a selection of the one or more DSPs provided by the advertiser using the UI. The selection of each DSP from among the one or more DSPs is associated with a selection of a respective frequency capping condition by the advertiser. The apparatus receives a selection of an overall frequency capping condition provided by the advertiser using the UI. The overall frequency capping condition is selected in relation to the Ad campaign. Subsequent to receiving the selection of the respective frequency capping condition for each DSP and the overall frequency capping condition for the Ad campaign, the apparatus tracks a number of Ad impressions related to the Ad campaign for an online visitor. The apparatus determines whether at least one of the overall frequency capping condition and the respective frequency capping condition associated with at least one DSP from among the one or more DSPs is satisfied based on the tracking of the number of Ad impressions. The apparatus causes the at least one DSP to stop display of one or more advertisements associated with the Ad campaign to the online visitor for a predefined time period if it is determined that at least one of the overall frequency capping condition and the respective frequency capping condition associated with the at least one DSP is satisfied.

In an embodiment of the invention, another computer-implemented method for facilitating management of a digital advertisement (Ad) campaign is disclosed. The method selects, by a processor, a respective frequency capping condition for each demand-side platform (DSP) from among one or more DSPs and an overall frequency capping condition in relation to the Ad campaign. At least one machine learning model is used to predict the respective frequency capping condition for each DSP and the overall frequency capping condition. Subsequent to selecting the respective frequency capping condition for each DSP and the overall frequency capping condition for the Ad campaign, the method tracks by the processor, a number of Ad impressions related to the Ad campaign for an online visitor. The method determines by the processor, whether at least one of the overall frequency capping condition and the respective frequency capping condition associated with at least one DSP from among the one or more DSPs is satisfied based on the tracking of the number of Ad impressions. The method causes the at least one DSP, by the processor, to trigger a negative audience pixel (NAP) to respective one or more Ad publishers to stop display of one or more advertisements associated with the Ad campaign to the online visitor for a predefined time period if it is determined that at least one of the overall frequency capping condition and the respective frequency capping condition associated with the at least one DSP is satisfied.

### BRIEF DESCRIPTION OF THE FIGURES

FIG. 1A shows a representation depicting an advertisement provided to an online visitor, in accordance with an example scenario;

FIG. 1B shows a block diagram illustrating exchanges between various components of an Ad network for providing an advertisement to an online visitor, in accordance with an example scenario;

FIG. 2A-2B is a block diagram of an apparatus configured to facilitate management of a digital advertisement (Ad) campaign, in accordance with an embodiment of the invention;

FIG. 3 shows an example UI presented to an advertiser for setting frequency capping conditions, in accordance with an embodiment of the invention;

FIG. 4 is a sequence diagram for illustrating a process flow associated with managing a providing of an Ad to an online visitor, in accordance with an embodiment of the invention;

FIG. 5 shows a flow diagram of a method for facilitating management of a digital Ad campaign, in accordance with an embodiment of the invention; and

FIG. 6 shows a flow diagram of a method for facilitating management of a digital Ad campaign, in accordance with another embodiment of the invention.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

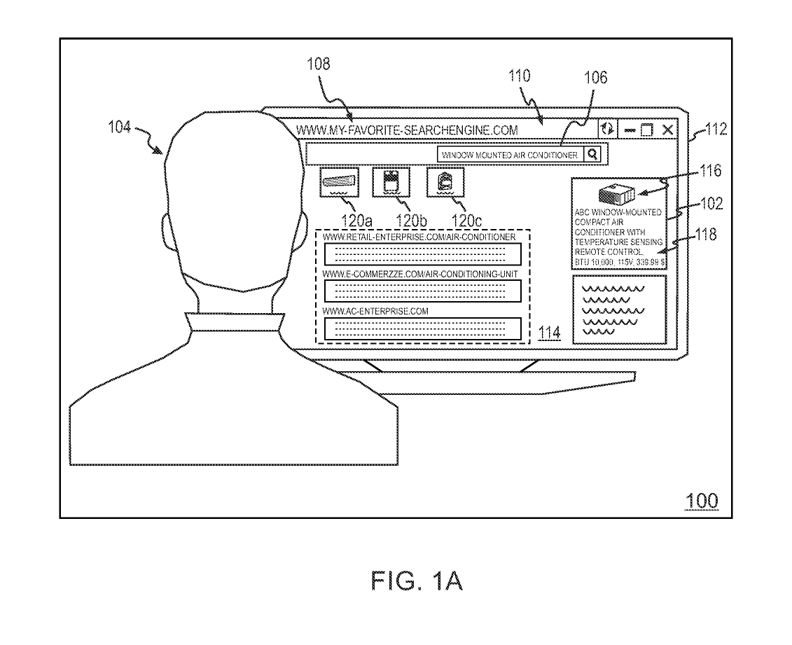

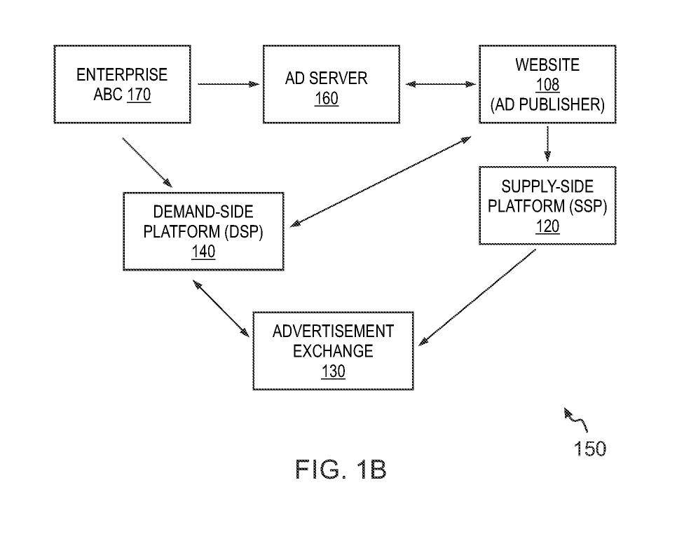

FIG. 1A shows a representation 100 depicting an advertisement 102 provided to an online visitor 104, in accordance with an example scenario.

In an example scenario, the online visitor 104 may wish to purchase an air conditioning unit and accordingly may enter a textual input such as for example ‘WINDOW MOUNTED AIR CONDITIONER’ in a search box 106 displayed on a website 108. In the representation 100, the website 108 is exemplarily depicted to be Web search engine service providing website ‘www.my-favorite-searchengine.com’. It is noted that the website 108 is depicted to be Web-search service providing website for illustration purposes. In some example scenarios, the website 108 may correspond to a website offered by an electronic commerce (E-commerce) entity, a retailer, a news website or any other website offered by a private or a public enterprise.

The online visitor 104 may access the web site 108 using a Web browser application 110 on an electronic device, exemplarily depicted to be a desktop computer 112. The online visitor 104 may alternatively use any other electronic device, such as a smartphone, a mobile phone, a tablet device, a laptop computer, a Web-enabled wearable device and the like, to access the website 108. The website 108 may be hosted on a remote Web server and the Web browser application 110 may be configured to retrieve one or more Web pages associated with the website 108 from the remote Web server over a communication network (not shown in FIG. 1A). Examples of the communication network may include wired networks, wireless networks and combinations thereof. Some examples of the wired networks may include Ethernet, local area networks (LAN), fiber-optic cable networks, and the like. Some examples of the wireless networks may include cellular networks like GSM/CDMA3G/4G/5G networks, wireless LANs, Bluetooth or ZigBee networks, and the like. Some examples of combination of the wired and wireless networks may include the Internet, Cloud based networks, and the like. The website 108 may attract a large number of existing and potential customers, such as the online visitor 104.

In response to the textual input of the online visitor 104 in the search box 106, the website 108 may be configured to load a Web page UI, such as a UI 114. The UI 114 is depicted to include one or more uniform resource locators (URLs) of websites associated with content related to air conditioning units. Further, one or more advertisements, such as the advertisement 102, advertisement 120a, advertisement 120b and advertisement 120c, may be displayed to the online visitor 104. For example, the advertisement 102 displayed to the online visitor 104 includes content related to a home air conditioning unit offered for sale by an enterprise ABC. The advertisement 102 is depicted to display an image 116 of the air conditioning unit and a text portion 118 including text such as ‘ABC WINDOW-MOUNTED COMPACT AIR CONDITIONER WITH TEMPERATURE SENSING REMOTE CONTROL, BTU 10,000, 115V, 339.99 $’. The advertisements, such as the advertisement 102, are designed to attract attention of online visitors and their primary aim is to persuade an online visitor to click on the advertisements so that the online visitor can then be directed to another website, where the online visitor may be displayed product specifications along with other details, such as for example delivery options, EMI options, etc. In many cases, the UIs accessed by the online visitors may be dynamically populated with advertisements without the online visitors providing any textual input or performing any search on the associated websites. The relevancy of advertisements displayed to the online visitors may be based on historical access patterns of the respective online visitors, or, based on individual profiles of the respective online visitors.

The display of advertisements, such as the advertisement 102, on visitor accessed UIs is further explained with reference to FIG. 1B.

FIG. 1B shows a block diagram 150 illustrating exchanges between various components of an Ad network for providing an advertisement to an online visitor, in accordance with an example scenario. The displaying of advertisements to online visitors is explained hereinafter in a simplified manner and may not be considered to be limiting the scope of the description. Providing or, more specifically, displaying advertisements may involve several other components and factors, which are not discussed herein.

In FIG. 1A, the online visitor 104 is depicted to have visited the website 108, i.e. www.my-favorite-search-engine.com. The website 108 includes one or more ad slots capable of receiving ads to be displayed to a user upon website or Web page access. As the website 108 includes one or more Web pages capable of displaying Ads to its users, the website 108 is hereinafter referred to as an ‘Ad publisher’. Ad publishers, such as the website 108, sell the advertising slots/spaces to advertisers, such as enterprise ABC 170 associated with the advertisement 102 (shown in FIG. 1A), without participating in tedious negotiations with advertisers directly as will be explained in further detail hereinafter.

Most Ad publishers typically include JavaScript (JS) embedded in their respective Web pages. When an access request for a Web page is received from an online visitor, the JS associated with the Web page is configured to send a request to Supply-Side Platform (SSP) 120.

The SSP 120 is a technology platform with which Ad publishers, such as the website 108, can make available their inventory, i.e. the advertisement slots, to a large number of potential buyers. The SSP 120 also enables the Ad publishers to set criteria on which advertisers can or cannot purchase their inventory and set the minimum prices for which their inventory can be sold to certain buyers.

When a JS request is received by the SSP 120, it in turn, is configured to send the request to an Advertisement exchange 130, hereinafter referred to as an ‘Ad exchange 130.’ An Ad exchange, such as the Ad exchange 130 is a trading platform that enables advertisers and publishers to buy and sell advertising space. In response to the receipt of request, the Ad Exchange 130 is configured to request bids from multiple demand-side platforms, such as a demand-side platform (DSP) 140. Only one DSP is shown herein for illustration purposes and that the Ad exchange 130 may request bids from multiple DSPs. A DSP is a system that allows buyers of digital advertising inventory, i.e. the advertisers, to manage multiple Ad exchanges and set Ad display preferences through a single interface.

The Ad exchange 130 passes information related to the Ad publisher, such as the Web URL, IP address, etc. to the DSPs. Each DSP now matches an advertiser from its database to the obtained publisher from the Ad exchange 130. This is done using complex algorithms involving machine learning, contextual data, natural language processing (NLP), and the like. Thereafter, each DSP creates a bid response including the bid amount, the advertiser information, the advertiser JS tag, etc., and sends the bid response to the Ad exchange 130.

In an example scenario, the DSP 140 may find the enterprise ABC 170 to be the best match for the information related to the Ad publisher and provide a bid on behalf of the enterprise ABC 170 to the Ad Exchange 130. After receiving the bids from all the DSPs, the Ad exchange 130 performs a real-time bidding (RTB) auction and chooses the DSP with the highest bid. In an example scenario, the bid response from the enterprise ABC 170 may be the highest bid and accordingly, the Ad exchange 130 may select the enterprise ABC 170 as the advertiser for a slot on the website 108. The highest bidder, i.e. the enterprise ABC 170, may pay an amount equal to the second highest bid as per second-price auction scheme. The Ad exchange 130 informs the DSP 140 of the selection of its bid and the DSP 140, in turn, and sends the response to the Ad publisher, i.e. the website 108.

The Ad publisher using the advertiser JS tag in the response, calls the advertiser's Ad server 160 asking for the advertisement, such as the advertisement 102 shown in FIG. 1A. The Ad server 160 is configured to store advertisements associated with the enterprise ABC 170. After receiving the advertisement from the Ad server 160, the Ad publisher, i.e. the website 108 displays the Ad on its page. The display of the advertisement 102 on the UI of the website 108 is exemplarily shown in FIG. 1A.

Ad campaign managers nowadays select multiple DSPs, such as the DSP 140, so that they can reach more inventories and can take advantage of different features including targeting strategies offered by multiple DSPs. However, managing an Ad campaign optimally across multiple DSPs is complicated and requires substantial effort on part of the Ad campaign managers. For example, optimally managing frequency capping configuration across multiple DSPs is especially a challenge. Frequency capping relates to the frequency with which an Ad is shown to an online visitor within a specified time period. In some cases, the optimal frequency capping needs to be applied at the household/family level rather than at an individual level to limit the ad exposure at a household level. As a result of such requirements, the complexity of optimally managing the frequency capping across DSPs increases substantially. Distributing frequency cap among multiple DSPs is a sub-optimal solution as such a solution can only work in cases when the frequency capping is more than number of DSPs. Furthermore, a segment of users may only available on one DSP and as such the segment of users may not be able to reach optimal frequency as a result of distributing frequency capping across DSPs.

Various embodiments of the invention provide a method and an apparatus that are capable of overcoming the above obstacles and of providing additional advantages. More specifically, various embodiments disclosed herein provide a method and apparatus for facilitating management of digital Ad campaigns. In at least one example embodiment, the apparatus is configured to be in operative communication with a plurality of demand-side platforms (DSPs) and is configured to facilitate frequency capping at a campaign level. For example, the apparatus may enable advertisers, or Ad agencies/marketers working on behalf of the Ad campaign managers/enterprises, to set frequency capping conditions for an Ad campaign at each DSP level as well as an overall campaign level, thereby providing control to the advertisers to control how aggressively they want to target their respective target users. Moreover, in some example scenarios, the apparatus enables advertisers to set frequency capping conditions at an individual level as well as at a household/family level so that display of advertisements can be optimally managed.

In at least one example embodiment, the apparatus is configured to keep track of all Ad impressions for an online visitor at an individual user level and at a household level spanning across different devices. The impressions information stored over time is used for evaluating if a total number of Ad impressions and number of impressions from serving DSP qualifies to send notification to one or all DSPs.

Most DSPs, nowadays, provide a negative audience pixel (NAP), which is used to stop targeting a particular online visitor for a fixed amount of time on occurrence of an event, such as the event related to the number of Ad impressions being greater than or equal to the frequency capping condition. Accordingly, if the frequency capping condition is satisfied, the apparatus is configured to notify one or all DSPs to trigger NAP to stop showing Ad(s) for a predefined period of time. The predefined period of time, also referred to herein as time to live (TTL) or expiration date for negative targeting for each user, may also be controlled using a machine learning (ML) model that predicts the optimum time and context that is more effective for the online visitor to be exposed to the Ad(s) and accordingly trigger the negative audience pixel with appropriate expiration time. For example, an online visitor who has already purchased an item may not be shown an Ad only for a week or a month.

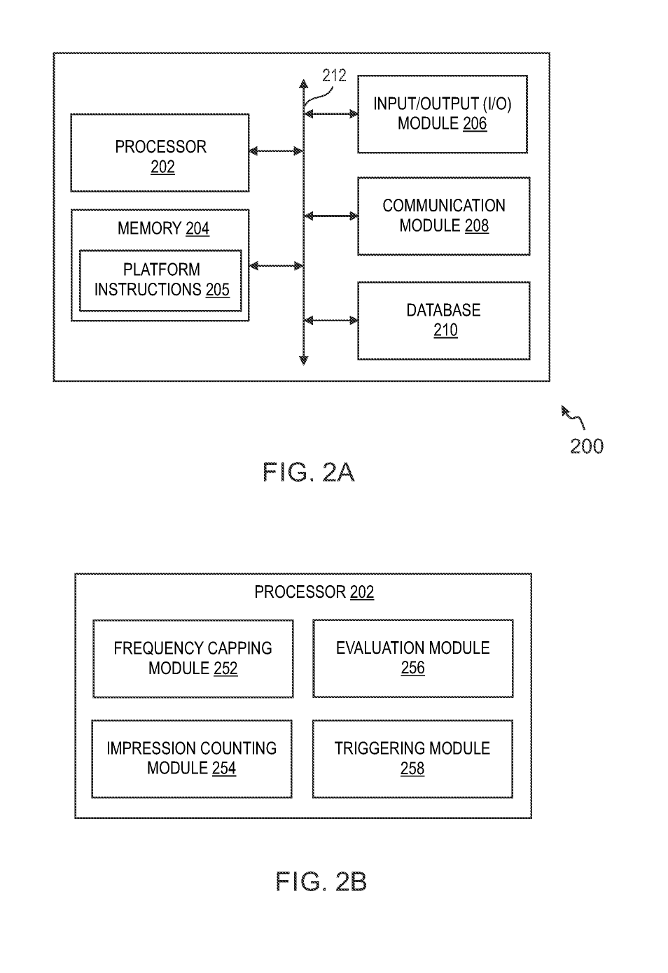

Such a solution of setting frequency capping condition at an individual DSP level, as well an overall Ad campaign level, keeping track of all Ad impressions for an online visitor to evaluate if any of the frequency capping conditions are satisfied, and then cause triggering of NAP from one or all DSPs if the conditions are met, enables Ad campaign managers to manage display of advertisements at a granular level of each online visitor. Moreover, optimally using multiple DSPs for an Ad campaign also enables the advertisers to take advantage of different features including targeting strategies offered by multiple DSPs. Further, the solution also enables the Ad campaign managers to set frequency capping for limiting the Ad exposure at the household/family level rather than at an individual level. An apparatus for facilitating management of digital Ad campaigns is explained next with reference to FIGS. 2A and 2B.

FIG. 2A is a block diagram of an apparatus 200 configured to facilitate management of advertisement campaigns, in accordance with an embodiment of the invention. The terms ‘digital advertisement campaign,’ ‘digital Ad campaign,’ or simply ‘Ad campaign’ as used interchangeably herein implies a single digital advertisement or a series of related digital advertisements associated with an enterprise, which are to be displayed to target online visitors for a pre-specified period of time. The term ‘facilitating management of digital Ad campaigns’ implies facilitating management of display of advertisements or in other words, managing Ad exposure for online visitors across devices in such a way that each online visitor is displayed an advertisement only till a frequency capping condition is met. Once the frequency capping condition is met for an online visitor, the online visitor is not displayed the advertisement till a predefined period of time. The terms ‘online visitor’ or ‘visitor’ as used interchangeably herein refer to any existing or potential user of enterprise offerings such as products, services and/or information, who is currently present on an advertisement channel such as a website or a native mobile application and is a suitable target for enterprise advertisement(s). The term ‘advertiser’ as used herein implies an enterprise or any entity acting on behalf of the enterprise for managing the Ad campaign, such as for example, the Ad campaign manager, the Ad agency, the marketer, and the like.

The apparatus 200 includes at least one processor, such as a processor 202 and a memory 204. It is noted that although the apparatus 200 is depicted to include only one processor, the apparatus 200 may include a greater number of processors therein. In an embodiment, the memory 204 is capable of storing machine executable instructions, referred to herein as platform instructions 205. Further, the processor 202 is capable of executing the platform instructions 205. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories, such as flash memory, mask ROM, PROM (programmable ROM), EPROM (erasable PROM), RAM (random access memory), etc.; magnetic storage devices, such as hard disk drives, floppy disks, magnetic tapes, etc.; optical magnetic storage devices, e.g. magneto-optical disks), CD-ROM (compact disc read only memory), CD-R (compact disc recordable), CD-R/W (compact disc rewritable), DVD (Digital Versatile Disc), and BD (BLU-RAY® Disc).

In addition to the platform instructions 205, in at least some embodiments, the memory 204 is configured to store one or more machine learning models configured to facilitate selection of optimal frequency conditions at a DSP level, overall campaign level, individual level, a household/family level, and the like. Some non-limiting examples of machine learning models may include models based on logistic regression, decision tree, random forest, Naïve-Bayes, kNN, K-Means, Support Vector Machines (SVM), and the like. The machine learning models are also trained to predict the optimal time and/or context for reinitiating display of one or more advertisements associated with the Ad campaign to the online visitor after the display of advertisements related to the Ad campaign was stopped for the online visitor. The memory 204 is also configured to store information such as a time interval defined by the advertiser for running an Ad campaign and/or a time frame for which the Ad impressions related to the Ad campaign are to be tracked for online visitors.

The apparatus 200 also includes an input/output module 206 (hereinafter referred to as an ‘I/O module 206’) and at least one communication module such as a communication module 208. In an embodiment, the I/O module 206 may include mechanisms configured to receive inputs from and provide outputs to the user of the apparatus 200. The term ‘user of the apparatus 200’ as used herein may refer to any individual, whether directly or indirectly, associated with Ad campaign management and/or with the enterprise and tasked with management of the digital Ad campaign. To enable reception of inputs and provide outputs to the user of the apparatus 200, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like.

In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication module 208 is configured to facilitate communication between the apparatus 200 and one or more remote entities over a communication network, such as a communication network explained with reference to FIG. 1A. For example, the communication module 208 may enable communication between the apparatus 200 and a plurality of Demand-Side Platforms (DSPs), with Ad servers, with Web servers hosting enterprise websites, and in some cases, with electronic devices of online visitors. For example, the communication module 208 may include relevant Application Programming Interfaces (APIs) to communicate with DSPs to receive information related to Ad slots for which corresponding bids have to be provided and also to cause the DSPs to trigger negative audience pixels (NAP) to respective one or more Ad publishers to stop display of Ads to online visitors if the frequency capping conditions are satisfied.

In an embodiment, the communication module 208 may include several channel interfaces to receive information from a plurality of enterprise advertisement channels. Some non-exhaustive examples of the enterprise advertisement channels may include a Web channel (for example, a third-party Website), a native mobile application channel, a social media channel, and the like. Each channel interface may be associated with a respective communication circuitry such as for example, a transceiver circuitry including antenna and other communication media interfaces to connect to the communication network. The communication circuitry associated with each channel interface may, in at least some example embodiments, enable transmission of data signals and/or reception of signals from remote network entities, such as Web servers hosting enterprise Website or a third-party Website. In some embodiments, the information may also be collated from a plurality of devices utilized by the online visitors. To that effect, the communication module 208 may be in operative communication with various customer touch points, such as electronic devices associated with the customers, Websites visited by the online visitors, and the like.

The information related to visitor activity on advertisement channels may be used to learn online access patterns of respective online visitors. The term ‘online access patterns’ as used herein refers to patterns of accessing and surfing advertisement channels, for example third-party websites also referred to as Ad publishers. In an illustrative example, an online visitor may visit an Ad publisher, i.e. a third-party website, during evenings on weekdays and in mornings on weekends. Further, the online visitor may use a tablet computer to access the Ad publisher on weekdays and a laptop to access the Ad publisher on weekends. Further, the online visitor's surfing activity may also be associated with a pattern of accessing Web pages, time spent on each Web page, content accessed on each Web page, and the like. Such information related to access timings, content accessed, access preferences, etc., may be learnt for each online visitor. The learned online access patterns may then be used to build visitor profiles and train machine learning models for prediction purposes.

The apparatus 200 is further depicted to include a database 210. The database 210 is any computer-operated hardware suitable for storing and/or retrieving data, such as, but not limited to, records related to a plurality of advertisers, a plurality of online visitors, and the like. In an illustrative example, each advertiser record may include enterprise name, Ad campaign description, period time the Ad campaign is to be active, and the like. In another illustrative example, each visitor record may include information such as visitor identification information; visitor device information, for example device type, device operating system, browser information etc.; IP address; and visitor contact information, for example email address, billing address, phone number etc. Each visitor record may also include a count of impressions across visitor devices. In at least some embodiments, the visitor record may further include information related to one or more members of the visitor's family and one or more devices associated with the members of the visitor's family. As such, the term ‘Ad impressions related to the online visitor’ as used herein may imply the Ad impressions of only the online visitor or the Ad impressions of the online visitor combined with the Ad impressions of the other members of the online visitor's family depending on how the apparatus 200 is configured to track the Ad impressions. Similarly, the term ‘devices related to the online visitor’ as used herein may imply the personal device(s) of only the online visitor or the personal device(s) of the online visitor combined with the personal device(s) of the other members of the online visitor's family, depending on how the apparatus 200 is configured to track the Ad impressions.

The database 210 may include multiple storage units, such as hard disks and/or solid-state disks in a redundant array of inexpensive disks (RAID) configuration. The database 210 may include a storage area network (SAN) and/or a network attached storage (NAS) system. In some embodiments, the apparatus 200 may include one or more hard disk drives as the database 210. In some embodiments, the database 210 is external to the apparatus 200 and may be accessed by the apparatus 200 using a storage interface (not shown in FIG. 2A). The storage interface is any component capable of providing the processor 202 with access to the database 210. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the database 210.

In an embodiment, various components of the apparatus 200, such as the processor 202, the memory 204, the I/O module 206, the communication module 208 and the database 210 are configured to communicate with each other via or through a centralized circuit system 212. The centralized circuit system 212 may be various devices configured to, among other things, provide or enable communication between the components (202-210) of the apparatus 200. In certain embodiments, the centralized circuit system 212 may be a central printed circuit board (PCB) such as a motherboard, a main board, a system board, or a logic board. The centralized circuit system 212 may also, or alternatively, include other printed circuit assemblies (PCAs) or communication channel media.

The apparatus 200 as illustrated and hereinafter described is merely an example of an apparatus that could benefit from embodiments of the invention and, therefore, should not be taken to limit the scope of the invention. The apparatus 200 may include fewer or more components than those depicted in FIG. 2A. In an embodiment, the apparatus 200 may be implemented as an interaction platform including a mix of existing open systems, proprietary systems and third-party systems. In another embodiment, the apparatus 200 may be implemented completely as a platform including a set of software layers on top of existing hardware systems. In an embodiment, one or more components of the apparatus 200 may be deployed in a Web Server. In another embodiment, the apparatus 200 may be a standalone component in a remote machine connected to a communication network and capable of executing a set of instructions, sequential and/or otherwise, to facilitate management of Ad campaigns. Moreover, the apparatus 200 may be implemented as a centralized system, or, alternatively, the various components of the apparatus 200 may be deployed in a distributed manner while being operatively coupled to each other. In an embodiment, one or more functionalities of the apparatus 200 may also be embodied as a client within devices, such as user devices. In another embodiment, the apparatus 200 may be a central system that is shared by or accessible to each of such devices. In an embodiment, the processor 202 may include a plurality of modules capable of facilitating management of digital Ad campaigns. The modules of the processor 202 are depicted in FIG. 2B.

FIG. 2B shows a block diagram of the processor 202 of the apparatus 200 of FIG. 2A, in accordance with an embodiment of the invention. The processor 202 is depicted to include a frequency capping module 252, an impression counting module 254, an evaluation module 256, and a triggering module 258. The various modules of the processor 202 may be implemented using software, hardware, firmware, or a combination thereof. In some example embodiments, the processor 202 may preclude the various modules and is configured to perform all the functions that are collectively performed by the frequency capping module 252, the impression counting module 254, the evaluation module 256 and the triggering module 258. Various modules of the processor 202 are depicted herein for example purposes and that the processor 202 may include fewer or more modules than those depicted in FIG. 2B.

In at least one example embodiment, the frequency capping module 252 is configured to enable advertisers to set frequency capping conditions for an Ad campaign at each DSP level as well as overall campaign level thereby providing control to the advertisers to control how aggressively they want to target their respective target users. To serve this purpose, in one embodiment, the frequency capping module 252 is configured to cause display of a user interface (UI) configured to provide options to an advertiser to select one or more demand-side platforms (DSPs) in relation to the Ad campaign. In one embodiment, selecting the frequency capping condition for each DSP may involve selecting, for example by typing or choosing from among displayed options, numerical values indicative of a maximum limit on display of the one or more advertisements on an hourly basis, daily basis and weekly basis. More specifically, the advertiser may select a daily, weekly and monthly limit of showing Ads to an online visitor. Additionally, the advertiser may also select an overall frequency capping condition that corresponds to a frequency capping condition for the entire Ad campaign.

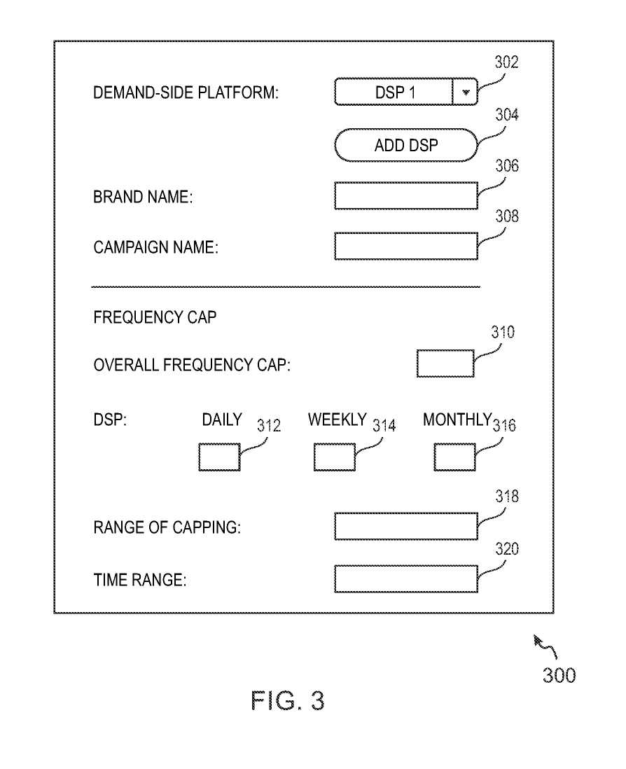

In one embodiment, the overall frequency capping condition selected for the Ad campaign is configured to be equal to the frequency capping condition selected for each DSP or a sum of the respective frequency capping condition selected for each DSP. More specifically, some advertisers may select an aggressive targeting strategy wherein the overall frequency capping and individual DSP capping is the same thereby allowing each DSP to participate with maximum possible impressions. Alternatively, some advertisers may select a configuration such that total frequency cap of individual DSPs is equal to the overall frequency capping. However, in most cases, the frequency capping for each DSP and the overall frequency capping may be selected by the advertiser/marketer based on respective considerations. An example UI presented to the advertiser for setting the frequency capping conditions is shown in FIG. 3.

Referring now to FIG. 3, an example UI 300 presented to an advertiser for setting frequency capping conditions is shown, in accordance with embodiment of the invention. As explained with reference to FIG. 2B, the frequency capping module 252 is configured to cause display of a user interface (UI) to enable advertisers to set frequency capping conditions for an Ad campaign at each DSP level as well as at an overall campaign level. An example UI presented to the advertiser is shown in FIG. 2B as the UI 300.

The UI 300 is depicted to include several form fields capable of receiving selection input from the advertiser. It is noted that the term ‘selection’ as used herein implies providing of an entry, whether in form of a manual text entry or by choosing from among displayed drop-down options or by clicking/touching on suitable choices from among several displayed choices. For example, form field 302 includes a drop-down menu for selecting a demand-side platform (DSP). The advertiser may select option 304 associated with text ‘Add DSP’ to make selection of multiple DSPs. The form fields 306 and 308 are configured to receiving textual input related to brand name and campaign name from the advertiser.

The UI 300 is further exemplarily depicted to display several form fields for setting the frequency capping condition. For example, form field 310 is configured to receive a numerical input corresponding to the overall frequency capping value from the advertiser. Form fields 312, 314 and 316 relate to daily, weekly, and monthly frequency capping for DSP 1. In an illustrative example, the advertiser may input numerical values ‘2’, ‘4’, and ‘10’ in the form fields 312, 314, and 316 implying that the advertisement associated with a particular Ad campaign can be shown at the most two times on a daily basis, four times in a week, and ten times in a month for each online visitor visiting any advertisement channel, such as a website, a mobile application, and the like. Accordingly, the frequency capping condition for DSP 1 corresponds to capping the frequency of displaying Ads at two times, four times, and ten times on a daily, weekly, and a monthly basis, respectively. The frequency capping condition may similarly be set for other DSPs, such as for example DSP 2, DSP 3, and so forth.

The capping related form fields in the UI 300 further include form fields 318 and 320 for receiving input related to the range of capping to be followed for a machine learning (ML) algorithm (the machine learning algorithm is further explained later) and a time range for visitor Ad impressions to be considered for evaluation. For example, the time range for visitor Ad impressions to be considered for evaluation may be chosen to be a month, i.e. one-month time period.

The apparatus 200 enables the user of the apparatus 200, i.e. the advertiser, to select multiple DSPs for an Ad campaign, and further select a frequency capping condition for each of the multiple DSPs and an overall frequency capping condition for the Ad campaign.

Referring back to FIG. 2B, in at least some example embodiments, the apparatus 200 may also enable advertisers to set frequency capping conditions at an individual visitor level. For example, visitor A might be more suited to be targeted with overall capping of ‘3’ but other visitor B might be more suited to be targeted with overall capping of ‘4’. To that effect, the UI provisioned by the frequency capping module 252 may further include form fields to select frequency capping conditions for different visitor types.

In one embodiment, the frequency capping module 252 is configured to use one or more machine learning models to learn online access patterns related to an online visitor, or a visitor profile, and predict an optimal frequency capping condition for each DSP and an optimal overall frequency capping condition for the Ad campaign. The ML models are configured to look into historic and real time data to put a capping condition for an online visitor depending on performance. In addition, for each DSP, the frequency can be controlled based on time of the day and day of the week. For example, it may be more beneficial to have a higher frequency capping condition during weekends in the morning or in the evening during weekdays. The frequency capping module 252 may also be configured to use ML models to build visitor profiles to predict optimum frequency capping condition at visitor level or at a visitor profile level.

In one embodiment, the predicted optimal frequency capping condition for each DSP and the optimal overall frequency capping condition are configured to be provided as suggestions to the advertiser prior to the selection of the respective frequency capping condition for each DSP and the selection of the overall frequency capping condition by the advertiser. In one illustrative example, the form fields such as form fields 312, 314, and 316 on the UI 300 may be pre-populated on the UI 300 and the advertiser may choose to accept or revise the values in the form fields for setting the frequency capping conditions for the respective DSPs.

The frequency capping module 252 is configured to receive a selection of the one or more DSPs along with a selection of a respective frequency capping condition for each DSP provided by the advertiser using the UI, such as the UI 300. The frequency capping module 252 is also configured to receive a selection of an overall frequency capping condition provided by the advertiser using the UI. It is noted that in some embodiments, the various frequency capping conditions are selected by the frequency capping module 252 itself using ML models without any involvement from the advertiser.

Subsequent to selecting or receiving the selection of the respective frequency capping condition for each DSP and the overall frequency capping condition for the Ad campaign, the frequency capping module 252 is configured to provide the information related to frequency capping conditions to the impression counting module 254.

The impression counting module 254 is configured to track a number of Ad impressions related to the Ad campaign for an online visitor. In at least one example embodiment, the impression counting module 254 is configured to keep track of all Ad impressions for an online visitor at an individual level or household level spanning across different devices. In one embodiment, access of one or more Ad publishers by a plurality of devices related to the online visitor is tracked to track the number of Ad impressions related to the Ad campaign for the online visitor. As explained above, the apparatus 200 is configured to be in operative communication with servers capable of recording visitor activity on advertising channels, such as a website, a mobile application, and the like. For example, the communication module 208 may be in operative communication with web servers hosting websites, i.e. advertisement channels. The content on the Web pages of the websites, such as for example images, hyperlinks, tabs, etc., are tagged with hypertext markup language (HTML) tags or JavaScript (JS) tags, such that visitor selection of the content may trigger an API call, which is recorded in the corresponding Web server. Accordingly, the access of Web pages bearing the Ad, or even a click on the Ad, may be recorded and provided to the communication module 208, which in turn, may provide the information to the impression counting module 254.

The impression counting module 254 is configured to keep track of Ad impressions (or in other words views of the advertisement) for each visitor and across visitor devices. For example, a visitor may visit a Web page using a desktop computer and be shown a particular Ad while on the Web page. At a later point in time, if the visitor accesses a mobile application using her Smartphone and is shown the same Ad, then the number of impressions for the visitor is counted as two, and so on and so forth.

In one embodiment, the impression counting module 254 is configured to store following information for each recorded impression:
1. An ID Map (for example, cookie information, any third-party identifiers, household information etc.)
2. Brand name
3. Campaign name
4. DSP
5. Time stamp
6. Optimization score

Optimization score is computed by running ML models on historic and real-time data. The optimization score facilitates in determination of the optimal value for frequency capping based on configured range.

The number of Ad impressions tracked over time is used by the evaluation module 256 for determining whether at least one of the overall frequency capping condition and the respective frequency capping condition associated with at least one DSP is satisfied. More specifically, the evaluation module 256 is configured to determine if the number of Ad impressions served by a DSP is equal to a frequency capping condition for the corresponding DSP or whether the total number of Ad impressions is equal to the overall frequency capping condition. If the number of Ad impressions served by a DSP is equal to the frequency capping condition for the respective DSP or if the total number of Ad impressions is equal to the overall frequency capping condition, then it is determined that the frequency capping condition is satisfied or met. If the evaluation module 256 determines that a frequency capping condition is satisfied then the evaluation module 256 is configured to initiate a call, for example an API call, to the triggering module 258.

The triggering module 258 is configured to cause at least one DSP to stop display of one or more advertisements associated with the Ad campaign to the online visitor for a predefined time period if it is determined that at least one of the overall frequency capping condition and the respective frequency capping condition associated with at least one DSP is satisfied. In an illustrative example, DSP 1 from among the one or more selected DSPs is caused to stop display of the one or more advertisements associated with the Ad campaign to the online visitor for the predefined time period if it is determined that the frequency capping condition associated with the DSP 1 is satisfied. In another illustrative example, all DSPs from among the selected one or more DSPs are caused to stop display of the one or more advertisements associated with the Ad campaign to the online visitor for the predefined time period if it is determined that the overall frequency capping condition is satisfied.

In one embodiment, for causing the at least one DSP to stop display of the one or more advertisements, the triggering module 258 is configured to cause the at least one DSP to trigger a negative audience pixel (NAP) to respective one or more Ad publishers configured to display the one or more advertisements. More specifically, the triggering module 258 is configured to include a data structure (also referred to herein as ‘Pixel’) associated with an end point, such as an DSP for example, and from where to call that end point. Subsequent to receiving the call from the evaluation module 256, the triggering module 258 is configured to call one or more DSPs to trigger the negative audience pixel. Most DSPs provide negative audience pixel, which is used to stop targeting an online visitor for a fixed amount of time (referred to herein as predefined time period) on occurrence of an event, such as the event related to the number of Ad impressions being equal to the frequency capping condition. A most common example of the same is to stop showing Ad to a visitor, who has already purchased an item, only for a week or a month.

The time to live (TTL) or expiration date for negative targeting for each visitor can also be controlled by a ML model. The triggering module 258 is configured to cause triggering of the negative audience pixel with appropriate expiration time. Accordingly, the advertisement is only displayed to the user upon completion of the expiration time. Furthermore, the triggering module 258 may use the machine learning model to predict an optimum time and context for reinitiating display of the one or more advertisements associated with the Ad campaign to the online visitor. For example, the display of Ads may be reinitiated on a weekend or when the online visitor is accessing the Ad publisher using a particular device, and so on and so forth, based on the prediction by the ML model of the most optimum time/context of displaying the Ad to the online visitor.

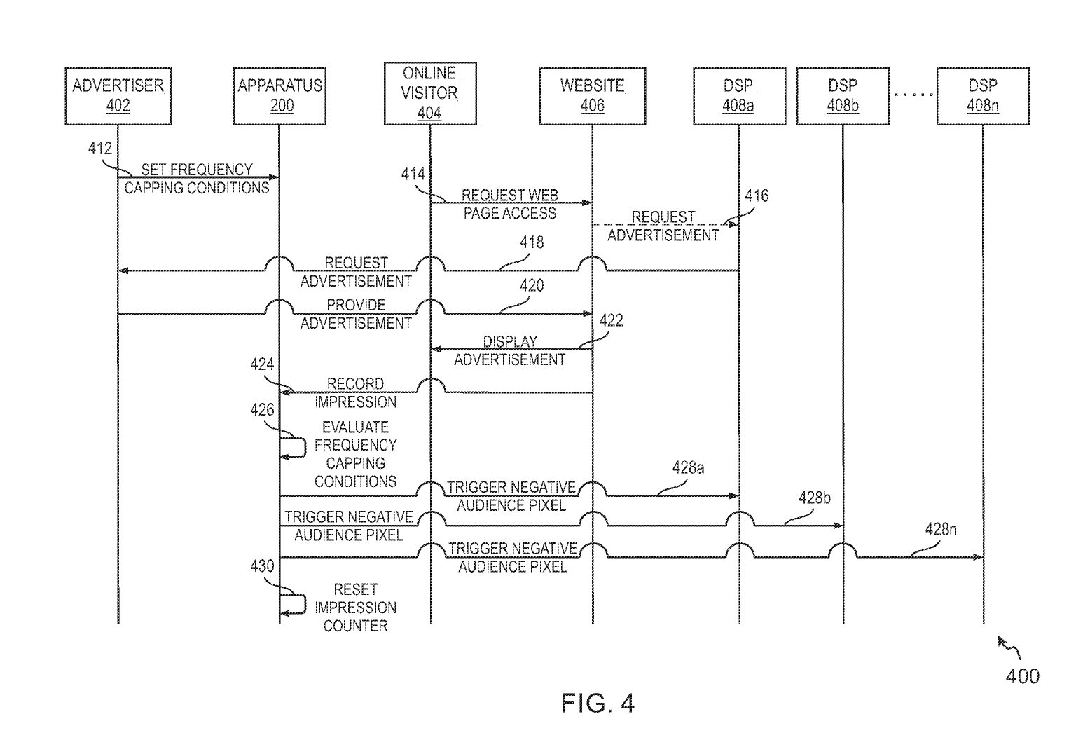

The overall process flow for providing a digital advertisement to an online visitor is explained with reference to a sequence diagram in FIG. 4.

FIG. 4 is a sequence diagram 400 for illustrating a process flow associated with managing a provisioning of an Ad to an online visitor, in accordance with an embodiment of the invention.

The sequence flow diagram 400 depicts an advertiser 402, the apparatus 200 explained with reference to FIGS. 2A, 2B and 3, an online visitor 404, an advertising channel such as a website 406, and a plurality of DSPs such as DSP 408a, DSP 408b, and DSP 408n. The process flow 400 starts at 412.

At 412 of the process flow 400, the advertiser 402 using the apparatus 200 sets frequency capping conditions for an Ad campaign. As explained with reference to FIG. 3, the apparatus 200 is configured to cause display of an UI, such as the UI 300, on an electronic device associated with the advertiser 402 subsequent to the accessing of the apparatus 200 by the advertiser 402. The advertiser 402 may use the UI to select DSPs, set frequency capping conditions for each DSP, set overall frequency capping condition for the entire Ad campaign, and the like. Further, as explained with reference to FIG. 2, in at least some example embodiments, the apparatus 200 may include machine learning models capable of providing suggestions (or alternatively selecting) the frequency capping conditions for the Ad campaign.

At 414 of the process flow 400, the online visitor 404 may request access of Web page of the website 406. The website 406 is one form of advertising channel among several other forms of advertising channels. The term ‘advertising channel’ as used herein implies a website or an online portal capable of displaying third-party advertisements. In some embodiments, the advertising channel may be a mobile application.

At 416 of the process flow 400, a DSP 408a may be notified to serve an advertisement corresponding to the Ad campaign on the requested Web page. Although the website 406 is depicted to communicate with the DSP 408a to serve the advertisement to the Web page, an entire process of selecting the DSP/Ad is performed prior to the intimating the DSP for providing the advertisement. More specifically, subsequent to receiving the visitor request for Web page access, a JavaScript (JS) request is sent to a Supply-side platform (SSP) (shown in FIG. 1B), which in turn sends the request to an Ad exchange, such as Google® double-click Manager® or InMobi® Ad exchange. The ad exchange invites bids for Ad display from multiple DSPs, such as the DSPs 408a-408n for displaying advertisement on the Web page and performs a real-time bidding auction to select the winner of the auction. In an example scenario, the DSP 408a may be selected as the winner of the bid and may be notified of the bid result. Accordingly, the indirect communication between the website 406 and the DSP, i.e. communication involving SSPs and Ad exchange, is represented using a dotted connector at 416.

At 418 of the process flow 400, the DSP 408a may be configured to communicate the notification to the advertiser 402. More specifically, the DSP 408a may be configured to communicate the notification to an Ad server associated with the advertiser 402. The advertiser 402 may be configured to provide the advertisement for display on the Web page of the website 406 at 420 of the process flow 400. Although the advertiser 402 is depicted to display provisioning of the advertisement to the website 406, the advertisement is provided by the Ad server associated with the advertiser 402 to the Web page associated with the website 406. At 422 of the process flow 400, the advertisement from the advertiser 402 is displayed on the Web page requested by the online visitor 404 for visitor consumption.

At 424 of the process flow 400, the apparatus 200 records the display of the advertisement as an impression. As explained with reference to FIG. 2, the apparatus 200 keeps track of impressions of the advertisement for each user across several channels and user devices.

At 426 of the process flow 400, the apparatus 200 evaluates if a frequency capping (FC) condition is met after the display of the advertisement to the online visitor 404. If the frequency capping condition is not met, then the displaying of the advertisement may be continued upon subsequent visit by the online visitor 404 to advertising channels until the frequency capping condition is met. If the frequency capping condition is met, then the apparatus 200 is configured to intimate advertiser selected DSPs, as shown by the process flow 428a, 428b, and 428n, to trigger the negative audience pixel to stop display of the advertisement until a predefined time period. At 430 of the process flow 400, the apparatus 200 resets the impression counter for the online visitor 404. The process flow 400 ends at 430.

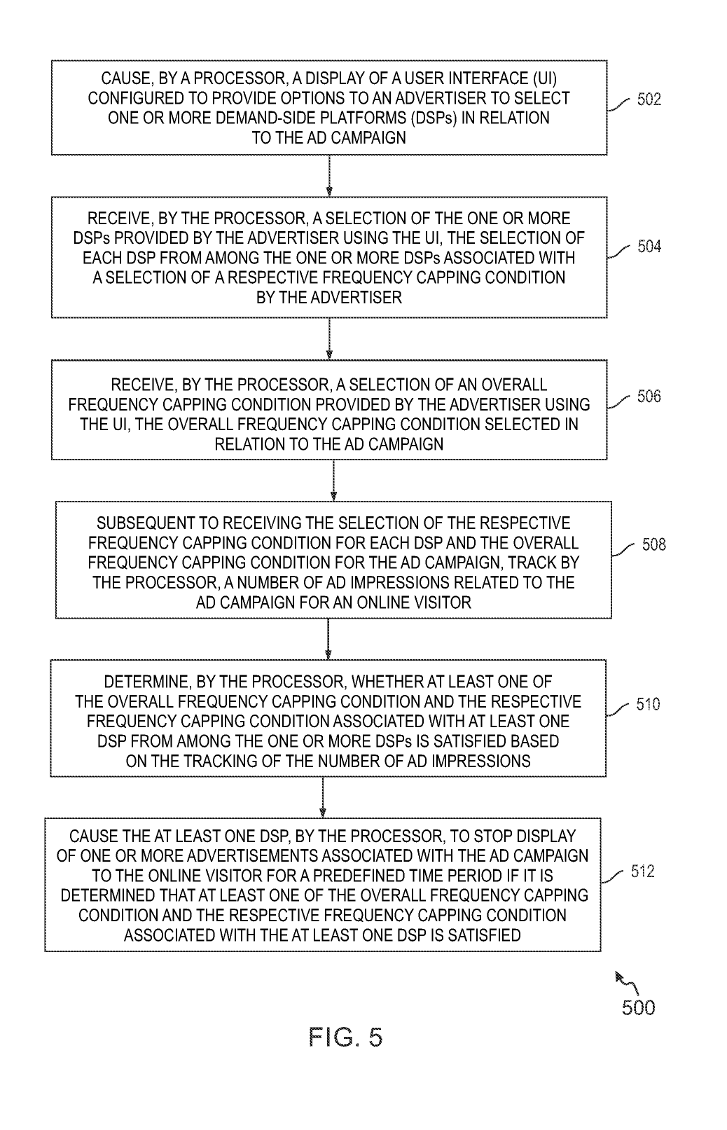

A method for facilitating management of a digital Ad campaign is explained next with reference to FIG. 5.

FIG. 5 shows a flow diagram of a method 500 for facilitating management of a digital Ad campaign, in accordance with an embodiment of the invention. The method 500 depicted in the flow diagram may be executed by, for example, the apparatus 200 explained with reference to FIG. 2A to 4. Operations of the flowchart, and combinations of operation in the flowchart, may be implemented by, for example, hardware, firmware, a processor, circuitry and/or a different device associated with the execution of software that includes one or more computer program instructions. The operations of the method 500 are described herein with help of the apparatus 200. It is noted that, the operations of the method 500 can be described and/or practiced by using any system other than the apparatus 200. The method 500 starts at operation 502.

At operation 502 of the method 500, a display of a user interface (UI) configured to provide options to an advertiser to select one or more demand-side platforms (DSPs) in relation to the Ad campaign is caused by a processor, such as the processor 202 of the apparatus 200 explained with reference to FIG. 2A.

As explained with reference to FIGS. 2B and 3, an UI configured to enable an advertiser to make selections for DSPs and the setting the frequency capping condition for each DSP as well as the overall frequency capping condition is provided to the advertiser by the apparatus 200. An example UI provided to the advertiser and example options for setting the frequency capping conditions are shown in FIG. 3 and are not explained again herein. The frequency capping may be set an individual visitor level as well as at a household/family level. Further, the processor may use machine learning models, which are configured to suggest optimal frequency capping values based on historic and real-time data related to visitor behavior on advertising channels to facilitate setting of frequency capping conditions.

At operation 504 of the method 500, a selection of the one or more DSPs provided by the advertiser using the UI is received by the processor. The selection of each DSP from among the one or more DSPs is associated with a selection of a respective frequency capping condition by the advertiser. At operation 506 of the method 500, a selection of an overall frequency capping condition provided by the advertiser using the UI is received by the processor. The overall frequency capping condition is selected in relation to the Ad campaign.

Subsequent to receiving the selection of the respective frequency capping condition for each DSP and the overall frequency capping condition for the Ad campaign, a number of Ad impressions related to the Ad campaign for an online visitor is tracked by the processor at operation 508 of the method 500. The impressions may be tracked across various electronic devices related with the online visitor. The processor is configured to keep track of impressions (or in other words views of the advertisement) for each visitor and across visitor devices. For example, a visitor may visit a Web page using a desktop computer and be shown a particular Ad while on the Web page. At a later point in time, if the visitor accesses a mobile application using her Smartphone and is shown the same Ad, then the number of impressions for the visitor is counted as two, and so on and so forth.

In one embodiment, access of one or more Ad publishers by plurality of devices related to the online visitor may be tracked to track the Ad impressions related to the Ad campaign for the online visitor. As explained with reference to FIG. 2A, the apparatus may be configured to be in operative communication with servers capable of recording user activity on advertising channels, such as a website, a mobile application, and the like. The content on the Web pages of the websites, such as for example images, hyperlinks, tabs, etc., are tagged with hypertext markup language (HTML) tags or JavaScript (JS) tags, such that visitor selection of the content may trigger an API call, which is recorded in the corresponding Web server. Accordingly, the access of Web pages bearing the Ad, or even a click on the Ad, may be recorded and provided to the apparatus for tracking of Ad impressions of the online visitor.

At operation 510 of the method 500, it is determined by the processor whether at least one of the overall frequency capping condition and the respective frequency capping condition associated with at least one DSP is satisfied based on the tracking of the number of Ad impressions. More specifically, the processor is configured to determine if the number of Ad impressions served by a DSP is equal to the frequency capping condition for the respective DSP or whether the total number of Ad impressions is equal to the overall frequency capping condition. If the number of Ad impressions served by a DSP is equal to the frequency capping condition for the respective DSP or if the total number of Ad impressions is equal to the overall frequency capping condition, then it is determined that the frequency capping condition is satisfied or met.

At operation 512 of the method 500, at least one DSP from among the one or more DSPs is caused by the processor to stop display of one or more advertisements associated with the Ad campaign to the online visitor for a predefined time period if it is determined that at least one of the overall frequency capping condition and the respective frequency capping condition associated with at least one DSP is satisfied. In one embodiment, a DSP from among the one or more selected DSPs is caused to stop display of the one or more advertisements associated with the Ad campaign to the online visitor for the predefined time period if it is determined that the respective frequency capping condition associated with the DSP is satisfied. In one embodiment, all DSPs from among the one or more selected DSPs are caused to stop display of the one or more advertisements associated with the Ad campaign to the online visitor for the predefined time period if it is determined that the overall frequency capping condition is satisfied.

In one embodiment, for causing the at least one DSP to stop display of the one or more advertisements, the processor is configured to cause the at least one DSP to trigger a negative audience pixel (NAP) to respective one or more Ad publishers configured to display the one or more advertisements. Accordingly, the advertisement is only displayed to the visitor upon completion of the expiration time. Furthermore, the processor may use the machine learning model to predict an optimum time and context for reinitiating display of the one or more advertisements associated with the Ad campaign to the online visitor. For example, the display of Ads may be reinitiated on a weekend or when the online visitor is accessing the Ad publisher using a particular device and so on and so forth, based on the prediction by the ML model of the most optimum time/context of displaying the Ad to the online visitor. The method 500 ends at operation 512.

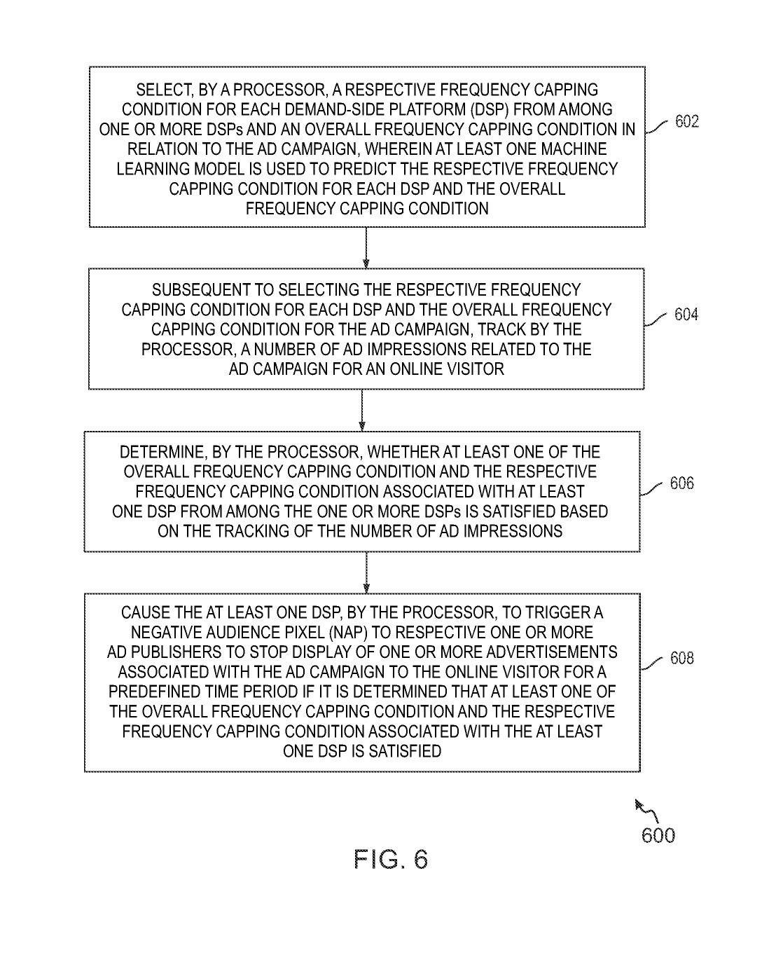

FIG. 6 shows a flow diagram of a method 600 for facilitating management of a digital Ad campaign, in accordance with another embodiment of the invention. The method 600 depicted in the flow diagram may be executed by, for example, the apparatus 200 explained with reference to FIG. 2A to 4. Operations of the flowchart, and combinations of operation in the flowchart, may be implemented by, for example, hardware, firmware, a processor, circuitry and/or a different device associated with the execution of software that includes one or more computer program instructions. The method 600 starts at operation 602.

At operation 602 of the method 600, a respective frequency capping condition for each demand-side platform (DSP) from among one or more DSPs and an overall frequency capping condition in relation to the Ad campaign is selected by a processor, such as the processor 202 of the apparatus 200 shown in FIG. 2A. In at least one embodiment, the processor is configured to use at least one machine learning model to predict the respective frequency capping condition for each DSP and the overall frequency capping condition. In one embodiment, the processor is configured to use one or more machine learning models to learn online access patterns related to an online visitor, or a visitor profile, and predict an optimal frequency capping condition for each DSP and an optimal overall frequency capping condition for the Ad campaign. The ML models are configured to look into historic and real time data to put a capping condition for an online visitor depending on performance. In addition, for each DSP, the frequency can be controlled based on time of the day and day of the week. For example, it may be more beneficial to have a higher frequency capping condition during weekends in the morning or in the evening during weekdays. The processor may also be configured to use ML models to build visitor profiles to predict optimum frequency capping condition at visitor level or at a visitor profile level.

Subsequent to selecting the respective frequency capping condition for each DSP and the overall frequency capping condition for the Ad campaign, a number of Ad impressions related to the Ad campaign for an online visitor is tracked by the processor at operation 604 of the method 600. At operation 606 of the method 600, it is determined by the processor whether at least one of the overall frequency capping condition and the respective frequency capping condition associated with at least one DSP from among the one or more selected DSPs is satisfied based on the tracking of the number of Ad impressions. The operations 604 and 606 may be performed as explained with reference to operations 508 and 510 and are not explained again herein.

At operation 608 of the method 600, at least one DSP from among the one or more DSPs is caused to trigger a negative audience pixel (NAP) to respective one or more Ad publishers to stop display of the one or more advertisements associated with the Ad campaign to the online visitor for a predefined time period if it is determined that at least one of the overall frequency capping condition and the respective frequency capping condition associated with at least one DSP is satisfied. More specifically, the processor is configured to include a data structure (also referred to herein as ‘Pixel’) associated with an end point, such as an DSP for example, and from where to call that end point. Subsequent to determining that the number of Ad impressions met a frequency capping condition, the processor is configured to call one or more DSPs to trigger the negative audience pixel. It is noted that most DSPs provide negative audience pixel, which is used to stop targeting an online visitor for a fixed amount of time (referred to herein as predefined time period) on occurrence of an event, such as the event related to the number of Ad impressions being equal to the frequency capping condition. A most common example of the same is to stop showing Ad to a user, who has already purchased an item, only for a week or a month.

The time to live (TTL) or expiration date for negative targeting for each user can also be controlled by a ML model. The processor is configured to cause triggering of the negative audience pixel with appropriate expiration time. Accordingly, the advertisement will only be displayed to the user upon completion of the expiration time. The method 600 ends at operation 608.

Various embodiments disclosed herein provide numerous advantages. The techniques disclosed herein suggest techniques for managing display of advertisements to online visitors by enabling advertisers to set frequency capping conditions at an individual DSP level, as well as at an overall campaign level. As a result, advertisers can take advantage of different features including targeting strategies offered by multiple DSPs. Further, the solution also enables the advertisers to set frequency capping for limiting the Ad exposure at the household/family level rather than individual user, thereby providing an optimal and granular manner of targeting users.

Various embodiments described above may be implemented in software, hardware, application logic, or a combination of software, hardware, and application logic. The software, application logic and/or hardware may reside on one or more memory locations, one or more processors, an electronic device or, a computer program product. In an embodiment, the application logic, software or an instruction set is maintained on any one of various conventional computer-readable media. In the context of this document, a “computer-readable medium” may be any media or means that can contain, store, communicate, propagate or transport the instructions for use by or in connection with an apparatus, as described and depicted in FIGS. 2A and 2B. A computer-readable medium may include a computer-readable storage medium that may be any media or means that can contain or store the instructions for use by or in connection with an instruction execution system, system, or device, such as a computer.

Although the invention has been described with reference to specific exemplary embodiments, various modifications and changes may be made to these embodiments without departing from the broad spirit and scope of the present invention. For example, the various operations, blocks, etc., described herein may be enabled and operated using hardware circuitry, for example complementary metal oxide semiconductor (CMOS) based logic circuitry; firmware; software; and/or any combination of hardware, firmware, and/or software, for example embodied in a machine-readable medium. For example, the apparatuses and methods may be embodied using transistors, logic gates, and electrical circuits, for example application specific integrated circuit (ASIC) circuitry and/or in Digital Signal Processor (DSP) circuitry.

Particularly, the apparatus 200 and its various components such as the processor 202 and its components described in FIG. 2B, the memory 204, the I/O module 206, the communication module 208, the database 210, and the centralized circuit system 212 may be enabled using software and/or using transistors, logic gates, and electrical circuits, for example integrated circuit circuitry such as ASIC circuitry. Various embodiments of the invention may include one or more computer programs stored or otherwise embodied on a computer-readable medium, wherein the computer programs are configured to cause a processor or computer to perform one or more operations, for example operations explained herein with reference to FIGS. 5 and 6.

A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media, such as floppy disks, magnetic tapes, hard disk drives, etc.; optical magnetic storage media, e.g., magneto-optical disks, CD-ROM (compact disc read only memory), CD-R (compact disc recordable), CD-R/W (compact disc rewritable), DVD (Digital Versatile Disc), BD (Blu-ray (registered trademark) Disc); and semiconductor memories, such as mask ROM, PROM (programmable ROM), EPROM (erasable PROM), flash ROM, RAM (random access memory), etc.

Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line, e.g., electric wires, and optical fibers, or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method for facilitating management of a digital advertisement (Ad) campaign, comprising:
causing, by a processor, a display of a user interface (UI) configured to provide options to an advertiser to select one or more demand-side platforms (DSPs) in relation to the Ad campaign;
receiving, by the processor, a selection of the one or more DSPs provided by the advertiser using the UI, the selection of each DSP from among the one or more DSPs associated with a selection of a respective frequency capping condition by the advertiser;
receiving, by the processor, a selection of an overall frequency capping condition provided by the advertiser using the UI, the overall frequency capping condition selected in relation to the Ad campaign;
subsequent to receiving the selection of the respective frequency capping condition for each DSP and the overall frequency capping condition for the Ad campaign, tracking by the processor, a number of Ad impressions related to the Ad campaign for an online visitor;
determining, by the processor, whether at least one of the overall frequency capping condition and the respective frequency capping condition associated with at least one DSP from among the one or more DSPs is satisfied based on the tracking of the number of Ad impressions; and
causing the at least one DSP, by the processor, to stop display of one or more advertisements associated with the Ad campaign to the online visitor for a predefined time period when it is determined that at least one of the overall frequency capping condition and the respective frequency capping condition associated with the at least one DSP is satisfied.

2. The method as claimed in claim 1, wherein causing the at least one DSP to stop display of the one or more advertisements comprises causing the at least one DSP to trigger a negative audience pixel (NAP) to respective one or more Ad publishers configured to display the one or more advertisements, the NAP configured to serve as an instruction to stop display of the one or more advertisements associated with the Ad campaign to the online visitor for the predefined time period.

3. The method as claimed in claim 2, wherein the predefined time period for stopping display of the one or more advertisements is determined based on prediction of an optimum time and context for reinitiating display of the one or more advertisements associated with the Ad campaign to the online visitor, and, wherein the optimum time and context are predicted by the processor using at least one machine learning model.

4. The method as claimed in claim 3, further comprising:
using the at least one machine learning model, by the processor, to learn online access patterns related to the online visitor and predict an optimal frequency capping condition for each DSP and an optimal overall frequency capping condition for the Ad campaign, wherein the optimal frequency capping condition for each DSP and the optimal overall frequency capping condition are configured to be provided as suggestions to the advertiser prior to the selection of the respective frequency capping condition for each DSP and the selection of the overall frequency capping condition by the advertiser.

5. The method as claimed in claim 1, wherein the selection of the respective frequency capping condition for each DSP comprises selection of numerical values indicative of a maximum limit on display of the one or more advertisements on a daily basis, weekly basis, and monthly basis.

6. The method as claimed in claim 1, wherein the number of Ad impressions related to the Ad campaign for the online visitor is tracked on at least one of an individual level and a family level.

7. The method as claimed in claim 6, wherein tracking the number of Ad impressions related to the Ad campaign comprises:
tracking access of one or more Ad publishers by a plurality of devices related to the online visitor, the one or more Ad publishers configured to display the one or more advertisements associated with the Ad campaign.

8. The method as claimed in claim 1, wherein the overall frequency capping condition selected for the Ad campaign is configured to be equal to one of:
the frequency capping condition selected for each DSP; and
a sum of the respective frequency capping condition selected for each DSP.

9. The method as claimed in claim 1, wherein a DSP from among the one or more DSPs is caused to stop display of the one or more advertisements associated with the Ad campaign to the online visitor for the predefined time period when it is determined that the respective frequency capping condition associated with the DSP is satisfied.

10. The method as claimed in claim 9, wherein all DSPs from among the one or more DSPs are caused to stop display of the one or more advertisements associated with the Ad campaign to the online visitor for the predefined time period when it is determined that the overall frequency capping condition is satisfied.

11. An apparatus for facilitating management of a digital advertisement (Ad) campaign, the apparatus comprising:
a memory for storing instructions; and
a processor configured to execute the instructions and thereby cause the apparatus to at least perform the steps of:
displaying a user interface (UI) configured to provide options to an advertiser to select one or more demand-side platforms (DSPs) in relation to the Ad campaign;
receiving a selection of the one or more DSPs provided by the advertiser using the UI, the selection of each DSP from among the one or more DSPs associated with a selection of a respective frequency capping condition by the advertiser;
receiving a selection of an overall frequency capping condition provided by the advertiser using the UI, the overall frequency capping condition selected in relation to the Ad campaign;
subsequent to receiving the selection of the respective frequency capping condition for each DSP and the overall frequency capping condition for the Ad campaign, tracking a number of Ad impressions related to the Ad campaign for an online visitor;
determining whether at least one of the overall frequency capping condition and the respective frequency capping condition associated with at least one DSP from among the one or more DSPs is satisfied based on the tracking of the number of Ad impressions; and
causing the at least one DSP to stop display of one or more advertisements associated with the Ad campaign to the online visitor for a predefined time period when it is determined that at least one of the overall frequency capping condition and the respective frequency capping condition associated with the at least one DSP is satisfied.

12. The apparatus as claimed in claim 11, wherein causing the at least one DSP to stop display of the one or more advertisements comprises causing the at least one DSP to trigger a negative audience pixel (NAP) to respective one or more Ad publishers configured to display the one or more advertisements, the NAP configured to serve as an instruction to stop display of the one or more advertisements associated with the Ad campaign to the online visitor for the predefined time period.

13. The apparatus as claimed in claim 12, wherein the predefined time period for stopping display of the one or more advertisements is determined based on prediction of an optimum time and context for reinitiating display of the one or more advertisements associated with the Ad campaign to the online visitor, and, wherein the optimum time and context are predicted by the apparatus using at least one machine learning model.

14. The apparatus as claimed in claim 13, wherein the apparatus is further caused to:
use the at least one machine learning model to learn online access patterns related to the online visitor and predict an optimal frequency capping condition for each DSP and an optimal overall frequency capping condition for the Ad campaign, wherein the optimal frequency capping condition for each DSP and the optimal overall frequency capping condition are configured to be provided as suggestions to the advertiser prior to the selection of the respective frequency capping condition for each DSP and the selection of the overall frequency capping condition by the advertiser.

15. The apparatus as claimed in claim 11, wherein the number of Ad impressions related to the Ad campaign for the online visitor is tracked on at least one of an individual level and a family level.

16. The apparatus as claimed in claim 11, wherein the overall frequency capping condition selected for the Ad campaign is configured to be equal to one of:
the frequency capping condition selected for each DSP; and
a sum of the frequency capping condition selected for each DSP.

17. The apparatus as claimed in claim 11, wherein a DSP from among the one or more DSPs is caused to stop display of the one or more advertisements associated with the Ad campaign to the online visitor for the predefined time period when it is determined that the respective frequency capping condition associated with the DSP is satisfied and, wherein all DSPs from among the one or more DSPs are caused to stop display of the one or more advertisements to the online visitor for the predefined time period when it is determined that the overall frequency capping condition is satisfied.

18. A computer-implemented method for facilitating management of a digital advertisement (Ad) campaign, the method comprising:
selecting, by a processor, a respective frequency capping condition for each demand-side platform (DSP) from among one or more DSPs and an overall frequency capping condition in relation to the Ad campaign, wherein at least one machine learning model is used to predict the respective frequency capping condition for each DSP and the overall frequency capping condition;
subsequent to selecting the respective frequency capping condition for each DSP and the overall frequency capping condition for the Ad campaign, tracking by the processor, a number of Ad impressions related to the Ad campaign for an online visitor;
determining, by the processor, whether at least one of the overall frequency capping condition and the respective frequency capping condition associated with at least one DSP from among the one or more DSPs is satisfied based on the tracking of the number of Ad impressions; and
causing the at least one DSP, by the processor, to trigger a negative audience pixel (NAP) to respective one or more Ad publishers to stop display of one or more advertisements associated with the Ad campaign to the online visitor for a predefined time period if it is determined that at least one of the overall frequency capping condition and the respective frequency capping condition associated with the at least one DSP is satisfied.

19. The method as claimed in claim 18, wherein the predefined time period for stopping display of the one or more advertisements is determined based on prediction of an optimum time and context for reinitiating display of the one or more advertisements associated with the Ad campaign to the online visitor, and, wherein the optimum time and context are predicted by the processor using at least one machine learning model.

20. The method as claimed in claim 18, wherein the number of Ad impressions related to the Ad campaign for the online visitor is tracked on at least one of an individual level and a family level.
